(19) United States
(12) Patent Application Publication
(10) Pub. No.: US 2026/0316366 A1
(43) Pub. Date: Oct. 15, 2026

(54) DEVICE FOR SETTING THE GAP OF A SLIT DIE

(71) Applicant: SBI MECHATRONIK GMBH, Hollabrunn (AT)

(72) Inventors: Franz KROTTENDORFER, Pulkau (AT); Johannes WEINKOPF, Röschitz (AT); Siddharth LOHIA, Kanpur Nagar (IN)

(21) Appl. No.: 19/122,438

(22) PCT Filed: Oct. 18, 2023
(86) PCT No.: PCT/AT2023/060355

§ 371 Date: Apr. 18, 2025

(30) Foreign Application Priority Data
Oct. 18, 2022 (AT) A50802/2022

(51) Int. Cl. B29C 48/31; B29C 48/08

(52) U.S. Cl. CPC B29C 48/313; B29C 48/08

(57) ABSTRACT

A device for adjusting the gap of a wide slot die for the production of flat web extrusion products, such as films, for example, where the slot die has a flexible lip, along the length of which a plurality of adjusting elements are arranged at regular intervals for adjusting the gap profile of the lip, where each adjusting element includes a drive, preferably in the form of a stepper motor, where the drive actuates a push rod which is connected in an articulated manner to the longer arm of a two-sided lever, and where the shorter arm of the lever cooperates with a linearly guided pressure pin which in turn acts on the flexible lip in order to adjust the gap in this region.

### TECHNICAL FIELD

The disclosure relates to a device for adjusting the gap of a wide slot die for the production of flat web extrusion products, such as films, wherein the wide slot die has a flexible lip, along the length of which a plurality of adjusting elements are arranged at regular intervals for adjusting the gap profile of the lip.

### BACKGROUND

Wide slot dies are used, for example, on extrusion lines for the production of plastic films and sheets and are also used in coating processes. In these extrusion lines, a thermoplastic material is melted and then exits through the gap of the slot die to form the material into a film shape. In this process, it is desired that the film web produced has a uniform thickness or a predefined profiling across the entire width. To achieve this, the gap must be preset to the desired thickness depending on the production process. After an initial start-up phase, the thickness profile of the produced film web can be measured in order to carry out a fine tuning. Depending on the material, the process speed and the specific parameters of the system, there may be deviations in the thickness profile during production, which are compensated for by adjusting the height of the nozzle gap at several points across the entire width of the slot die by means of adjusting elements on a flexible lip.

In the simplest case, these adjusting elements are screws that are turned manually and press with their lower ends against the flexible lip in order to adjust the nozzle gap. It requires a skilled person familiar with the system to make the adjustments. Adjustment in the event of deviations during operation is difficult and slow, resulting in material losses and associated additional costs. In the event of a product change, this also results in longer downtimes for the system until all the actuators are readjusted one after the other.

In order to enable fine adjustment of the profile during operation, thermo bolt units are usually used in the actuators. The coarse pre-setting of the system to the desired product is usually still done by hand using adjusting screws. This allows the gap height to be preset, for example, within a range of 1 to 3 mm. Fine adjustment during operation on the basis of the thickness profile produced is then carried out by means of thermal bolts, also known as thermal expansion bolts, on each adjusting element. These allow fine adjustment of the nozzle gap in the range of about 100 μm to 300 μm. The thermal bolts are thermal actuators that expand or contract due to the applied heating power and adjust the flexible lip and thus the nozzle gap. However, these thermal bolts permanently require a relatively high energy supply to provide the heating power, which leads to considerable additional operating costs for wider systems. In addition, it takes some time for the respective bolt to heat up or cool down during adjustment, which makes these thermal bolts sluggish in their reaction, which in turn leads to increased material loss. When the product is changed, the adjustment has to be done manually again due to the small possible adjustment range, which leads to the above-mentioned increased downtimes of the system.

EP 265700 A1 discloses a device for adjusting a slot die, in which a screw driver that can be moved on a crossbar running parallel to the slot die is used to actuate the adjusting screws of the setting elements, which would otherwise have to be actuated manually. This means that the adjusting elements can be actuated automatically when the product is changed and it is also possible to adjust the thickness profile during operation. The disadvantage of this is that the system requires a relatively high degree of control to ensure that the screw driver is correctly coupled to the adjusting screws each time. In addition, only one adjusting screw can be actuated at a time, which is faster than by hand due to the automation, but is still comparatively slow during operation. The adjusting screws of the actuators also have the problem that they can easily change their position during operation and thus require frequent readjustment.

In practice, automatic adjustment systems with numerous motors for individual adjusting screws mean that fewer adjusting elements can be placed next to each other. Since the motors have to generate a corresponding amount of power and therefore cannot be made small enough, the often desired distance of about 2.5 cm between two actuators cannot be maintained. Such systems are also very expensive due to the large number of motors, but at the same time do not allow high-resolution profile adjustment over the entire width of the die.

### BRIEF SUMMARY

It is therefore the task of the present disclosure to create a device for adjusting the gap of a slot die which eliminates the above-mentioned disadvantages and enables a high-resolution profile adjustment over the entire width of the slot die. The costs per actuator should be kept low and the actuators should remain self-locking in the respective position to avoid frequent readjustments. The adjusting elements should also be compact enough to be placed close to each other along the flexible lip of the slot die. A quick and exact adjustment at all actuators simultaneously in the range of the coarse adjustment as well as in the range of the fine adjustment during operation should be made possible. In addition, the device should only have a low thermal transition from the slot die and in particular from the flexible lip to the device itself.

This task is solved by the present disclosure in that each actuator comprises a drive, preferably in the form of a stepper motor, wherein the drive actuates a push rod which is hingedly connected to the longer arm of a two-sided lever, and wherein the shorter arm of the lever cooperates with a linearly guided pressure pin which in turn acts on the flexible lip in order to adjust the gap in this area. The arrangement with a two-sided lever makes it possible to apply the necessary forces for the adjustment range with a correspondingly small and inexpensive drive, for example in the form of an electric stepper motor. Due to the compact design, it is possible to place many of these actuators at a smaller distance from each other along the length of a slot die. Since each actuator is directly controlled, all of them can be adjusted simultaneously and thus both the coarse adjustment during product change and the fine adjustment during operation can be carried out precisely and quickly. The device also has a significantly lower energy requirement than known thermal bolt systems, which have to be permanently supplied with energy to maintain a profile. The device according to the disclosure, on the other hand, only consumes energy during the adjustment process itself. By applying the force via the linearly guided pressure pin in the front area of the flexible lip, it is also possible to make very precise adjustments with very little force, without the adjustments becoming misaligned over time. The two-sided lever allows a significant reduction in force during adjustment compared to devices where the entire lever force only acts on the pivot point of the flexible lip. Since the lever has an additional pivot point, the lever forces can be adjusted very easily, depending on the application, by moving the pivot point on the lever or changing the lever length, without affecting the accuracy of the adjustment, especially in the fine-tuning range. The device can thus be adapted to a wide variety of wide slot die devices with different force requirements simply by modifying the component of the lever.

According to a preferred embodiment, the push rod is a spindle with an external thread, which engages in a socket with an internal thread that can be rotated by the drive and is connected to the joint on the longer arm of the lever, or conversely, the spindle is directly rotated by the drive and engages in a socket with an internal thread that is connected to the joint on the longer arm of the lever. This design is particularly inexpensive to manufacture and results in selflocking of the push pins, which effectively prevents the same from moving during operation.

A further preferred feature is that the two-sided lever is an angle lever, whereby the longer arm of the lever is arranged in approximately the same longitudinal direction as the pressure pins and the shorter arm of the lever runs approximately normal to the longitudinal direction of the pressure pins. In this way, each actuating element can be realized and installed on the system in a particularly space-saving and compact manner.

It is also a preferred feature that the adjusting elements in the area of the pressure pins are arranged at a distance of about 2 cm to 3 cm, preferably about 2.5 cm, from each other along the slot die. This allows the thickness profile to be adjusted with a high resolution across the entire width of the slot die.

According to a preferred embodiment, it is a further feature that the actuating elements in the area of the drives are arranged offset to each other in two rows running parallel to the slot die, so that alternately one actuating element from one row and one from the other row are located next to each other. If the distance between the actuating elements is particularly narrow, they can be efficiently installed in two rows to save space.

It is a further preferred feature that the pressure pin is guided in a linearly movable manner in a connecting element, wherein the connecting element serves to connect the device to the slot die, and wherein the connecting element can be mounted in a corresponding receptacle on the slot die via two ridges. The connecting elements may further comprise thermally insulating materials or coatings. This makes it possible to thermally decouple the device from the slot die as far as possible, as contact with the slot die is only made in the area of the two ridges and via the tip of the pressure pins. The flexible lip of the slot die often has its own heating device so that the material to be extruded has the appropriate temperature at the outlet gap. It is desirable that the energy introduced here is not dissipated via the adjustment device. Otherwise, a high heat transfer from the slot die to the adjusting device would cause problems with the consistent quality of the film or at least lead to energy losses, as more heating power has to be introduced into the slot die, which is then only released into the environment via the adjusting device.

Another preferred feature is that the pressure pin is tapered or rounded at both ends so that the contact points between the flexible lip of the wide slot die and the pressure pin as well as between the pressure pin and the two-sided lever are as small as possible or almost point-shaped, whereby only a low direct heat transfer between these components is possible. Due to the few, largely point-shaped contact points with the in most cases heated flexible lip of the slot die and subsequently with the two-sided lever, there is only a low direct heat transfer between the slot die and the adjustment device, even during longer operation.

Finally, it is a further preferred feature that a control unit is provided which is connected to all drives of all actuating elements of a slot die, whereby the control unit brings the individual actuating elements into the desired position on the basis of sensor data about the current thickness profile of the extruded product and/or on the basis of user inputs. Existing systems can determine the thickness profile of the produced product in different ways while the extrusion process is running and make this data available to the operating personnel. A corresponding control unit can process this data directly in order to adjust the individual control elements to the desired profile at the same time. The user can also enter rough settings for the profile, for example when changing the product, after which all the control elements are adjusted simultaneously and quickly to the new profile entered.

### BRIEF DESCRIPTION OF THE DRAWINGS

The disclosure is now described in greater detail with the aid of an example of implementation and the accompanying figures.

FIG. 1 shows a schematic sectional view through an actuator,

FIG. 2 shows a schematic detailed front view of several actuators arranged in two rows and

FIG. 3 shows a schematic sectional view in the area of the pressure pins and the connection element on the slot die.

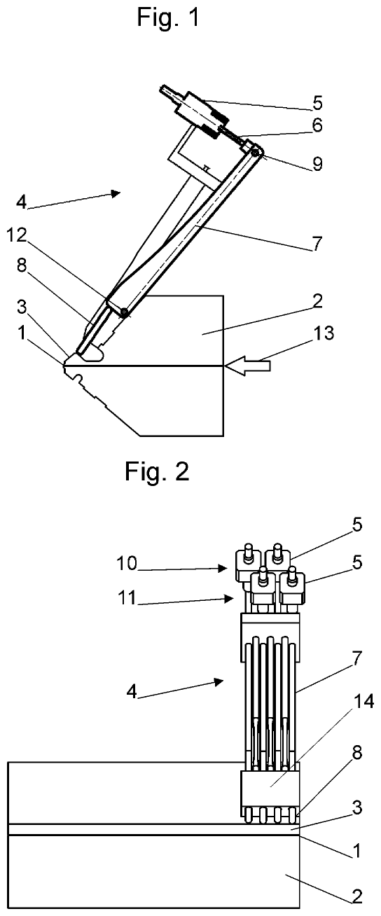

FIG. 1 shows a very schematic sectional view of a slot die 2 with an actuator 4 according to the disclosure. The material to be extruded is transported in the direction of the arrow 13 through the slot die 2 in the direction of the gap 1. The gap height is determined by the flexible lip 3, which can be adjusted at several points along the slot die 2 by means of the adjusting elements 4.

### DETAILED DESCRIPTION

Each actuator 4 has a drive 5, here in the form of a stepper motor, which actuates a push rod 6, for example a spindle. The push rod 6 is connected to a two-sided lever 7 via a joint 9. The lever 7 is mounted on the system with its pivot point 12. The push rod 6 engages the end of the longer lever arm to move it towards or away from the drive 5. In the embodiment example shown, the lever 7 is designed as an angle lever, whereby the short lever arm is designed as a thickening of the overall lever 7 and its direction of action is essentially normal to the direction of action of the first lever arm. Near the end of the short second lever arm, it comes into contact with a pressure pin 8. If the lever 7 is pulled via the push rod 6, for example in the direction of the drive 5, the second short lever arm presses the pressure pin 8 downwards onto the flexible lip 3 and the gap 1 of the slot die 2 is thus narrowed in this area. Independent resetting is prevented firstly by the fact that the point of engagement of the pressure pin on the short lever arm would have to apply a significantly higher force in order to move the first lever arm at all and secondly by the fact that the push rod 6, which is designed as a spindle, prevents unwanted movement in the axial direction of the drive 5.

FIG. 2 schematically shows four actuators 4 next to each other on a slot die 2. The actuators 4 are arranged in two rows 10,11, which means that they can be arranged very close to each other. In each case, an actuator 4 from the rear row 10 is alternately located next to an actuator 4 from the front row 11. Since the design of the actuators 4 requires little driving force to be applied via the relatively long levers 7, which nevertheless have to be compactly installed, in order to adjust the pressure pins 8 and thus the flexible lip 3, less expensive, weaker and thus smaller motors can also be used as drives 5, which is not possible in designs with directly driven adjusting screws or with transmission gears.

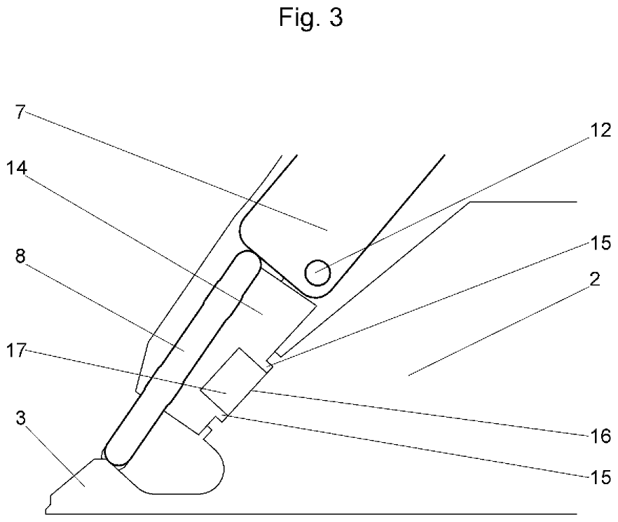

FIG. 3 shows a detailed section of the adjustment device in the front area of the wide slot nozzle 2. Only the upper part of the wide slot nozzle 2 with the flexible lip 3 is shown. The adjusting device is mounted via the webs 15 of a connecting element 14 on the wide slot nozzle 2 in a corresponding receptacle 16 provided for this purpose. Between the webs 15 there is a recess 17 in the connecting element 14 which allows air to pass through. The contact points between the slot die 2 and the connecting element 14 are therefore limited to this bearing area, whereby only a small direct heat transfer from the slot die 2 to the connecting element 14 and thus to the adjusting device is possible. The pressure pins 8 also have rounded end sections at both ends, which also minimizes the contact point between the flexible lip 3, which usually has its own heating device, and the pressure pin or between the pressure pin 8 and the lever 7. Here too, there can hardly be any direct heat transfer, which saves energy and increases the product quality of the extruded film.

1. Device for adjusting the gap of a wide slot die for the production of flat-web extrusion products, wherein the wide slot die has a flexible lip on the length of which a plurality of adjusting elements for adjusting the gap profile of the lip are arranged at regular intervals, wherein each adjusting element comprises a drive, in the form of a step motor, the drive actuating a push rod which is connected in an articulated manner to the longer arm of a two-sided lever and the shorter arm of the lever interacting with a linearly guided pressure pin which in turn acts on the flexible lip in order to adjust the gap in this region.

2. Device for adjusting the gap of a wide slot die according to claim 1, wherein the push rod is a spindle with an external thread which engages in a bushing with an internal thread which can be rotated by the drive and is connected to the joint on the longer arm of the lever, or conversely, the spindle is directly rotatably mounted by the drive and engages in an internally threaded bushing connected to the joint on the longer arm of the lever.

3. Device for adjusting the gap of a wide slot die according to claim 1, wherein the two-sided lever is an angle lever, the longer arm of the lever being arranged in approximately the same longitudinal direction as the pressure pins and the shorter arm of the lever extending approximately perpendicular to the longitudinal direction of the pressure pins.

4. Device for adjusting the gap of a wide slot die according to claim 1, wherein the adjusting elements are arranged in the region of the pressure pins along the slot die at a distance of about 2 cm to 3 cm, from one another.

5. Device for adjusting the gap of a wide slot die according to claim 1, wherein the adjusting elements are arranged in the region of the drives in two rows running parallel to the slot die, offset to each other, so that alternately one adjusting element of one row and one from the other row lie next to each other.

6. Device for adjusting the gap of a wide slot die according to claim 1, wherein the pressure pin is guided in a linearly movable manner in a connecting element, the connecting element serving to connect the device to the slot die, and the connecting element being able to be mounted in a corresponding receptacle on the slot die via two ridges.

7. Device for adjusting the gap of a wide slot die according to claim 1, characterized in wherein the pressure pin is tapered or rounded at both ends so that the points of contact between the flexible lip of the slot die and the pressure pin and between the pressure pin and the two-sided lever respectively are as small as possible or almost point-shaped, whereby only a small direct heat transfer is possible between these components.

8. Device for adjusting the gap of a wide slot die according to claim 1, wherein a control unit is provided which is connected to all drives of all actuating elements of a slot die, wherein the control unit brings the individual actuating elements into the desired position on the basis of sensor data about the instantaneous thickness profile of the extruded product and/or on the basis of user inputs.
